(19) United States
(12) Patent Application Publication
(10) Pub. No.: US 2020/0108578 A1
(43) Pub. Date: Apr. 9, 2020

(54) METHOD AND APPARATUS FOR MANUFACTURING TIRES

(71) Applicant: HARBURG-FREUDENBERGER MASCHINENBAU GMBH, Hamburg (DE)

(72) Inventors: Markus WACHTER, Ahrensburg (DE); Achim BEHRENS, Asendorf (DE); Thomas LANGE-KRAUEL, Hamburg (DE)

(21) Appl. No.: 16/621,199

(22) PCT Filed: May 11, 2018
(86) PCT No.: PCT/DE2018/000143

§ 371 Date: Dec. 10, 2019

(30) Foreign Application Priority Data
Jun. 16, 2017 (DE) 10 2017 005 818.0

(51) Int. Cl. B29D 30/32; B29D 30/24

(52) U.S. Cl. CPC B29D 30/32; B29D 2030/3214; B29D 2030/3264; B29D 30/244

(57) ABSTRACT

A method and a device for producing tires. The device is made up of, among other things, a tire-building drum including a device for realizing a ply turn-up for producing uncured tire blanks. A plurality of turn-up fingers of the ply turn-up is coupled to a drive unit arranged outside the tire-building drum. The drive takes place via synchronously driven spindles which are coupled to the tire-building drum with the help of movable carriers.

The invention relates to a method and a device for manufacturing tires. The device contains a tire-building drum with ply turn-up for producing uncured tire blanks.

Bladders are typically used in the production of uncured tire blanks to provide the necessary pressing forces during the ply turn-up. Drums of this kind are relatively expensive and make it necessary for the bladders to be replaced at predetermined cyclical intervals. EP-A 1 001 876 has also already disclosed how to realize mechanical bead turn-up devices in which the necessary pressure is achieved using a plurality of individual levers or turn-up fingers which are arranged in a similar manner to the spokes of an umbrella. These mechanical devices offer a longer service life compared with the use of bladders, but do not allow symmetrical travel.

A first problem addressed by the present invention is that of defining a method and constructing a device of the kind referred to above in such a manner that performing symmetrical traveling movements is supported.

This problem is solved according to the invention in that the ply turn-up has a plurality of roller arms or turn-up fingers which are coupled to a drive that is arranged outside the tire-building drum. In an advantageous embodiment of the device according to the invention, the drive is mounted in a fixed tire-building ring and is preferably made up of three spindles which are advantageously driven separately, in opposite directions, and synchronously. A torque control is preferably used as the control system. Servo motors are preferably used to adjust the spindles. AC or 3-phase current drives are likewise preferably used for this purpose.

Furthermore, the three spindles are preferably arranged in a circumferential direction spaced at substantially the same intervals relative to one another.

In an advantageous embodiment, the transmission of force from the drive spindles to the corresponding mechanisms integrated in the tire-building drum takes place via radially movable carriers.

By arranging the drive outside the tire-building drum, it is possible for the turn-up fingers to be actuated via a pusher which prescribes completely symmetrical travel movements. This makes it possible to produce tire blanks with a very high and consistent standard quality.

A further problem addressed by the invention is that of making the material pressing force capable of being used in a more efficient manner during the turn-up process.

This problem is solved according to the invention by a core-setting distance during the turn-up process which is greater than, or equal to, the smallest core-to-core distance during the remaining tire-building process. This means that compared with the prior art the tire blank is flatter during the turn-up process, based on a uniform turn-up length, and this gives rise to an advantageous force-angle combination.

A further problem addressed by the invention is that of engineering a device for producing tires in such a manner that tire blanks can be produced by both the flat-building and the crown-building method.

This problem is solved according to the invention in that a second drive unit is present in the carcass machine. In addition, the device according to the invention has an exchangeable tire-building drum which supports at least one building method in each case.

In an advantageous embodiment a device according to the invention for producing tires has a tire-building drum and a carcass machine. Moreover, in a preferred variant a device according to the invention for producing tires has a ply server with which the different material plies of the tire blank can be applied to the tire-building drum, a tread server with which the belt package or the material of the tread can be applied to a belt drum, and a tire-building ring in the region of which a tire blank can be produced from the material plies of the carcass applied to the tire-building drum in conjunction with the belt package.

Exemplary embodiments of the invention are depicted schematically in the drawings. In the drawings:

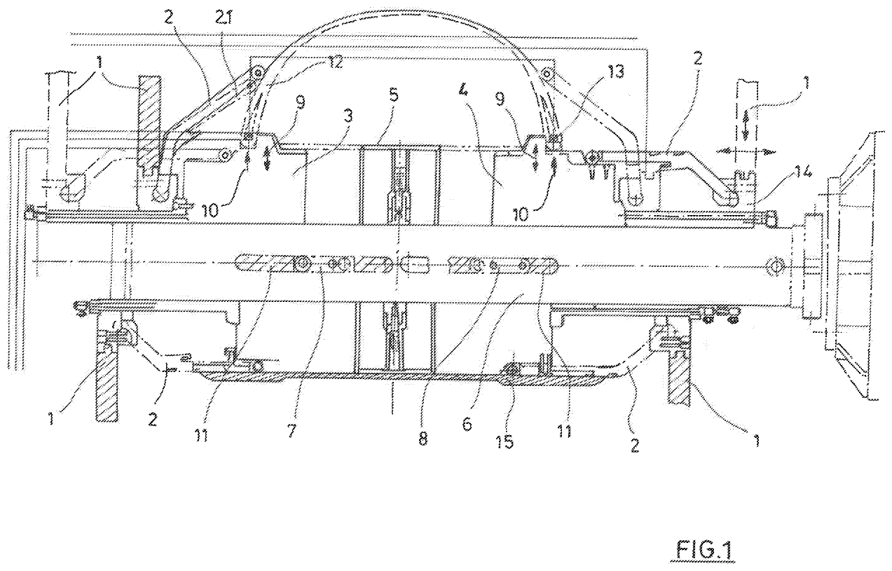

FIG. 1 shows a schematic longitudinal section through a tire-building drum with mechanical ply turn-up,

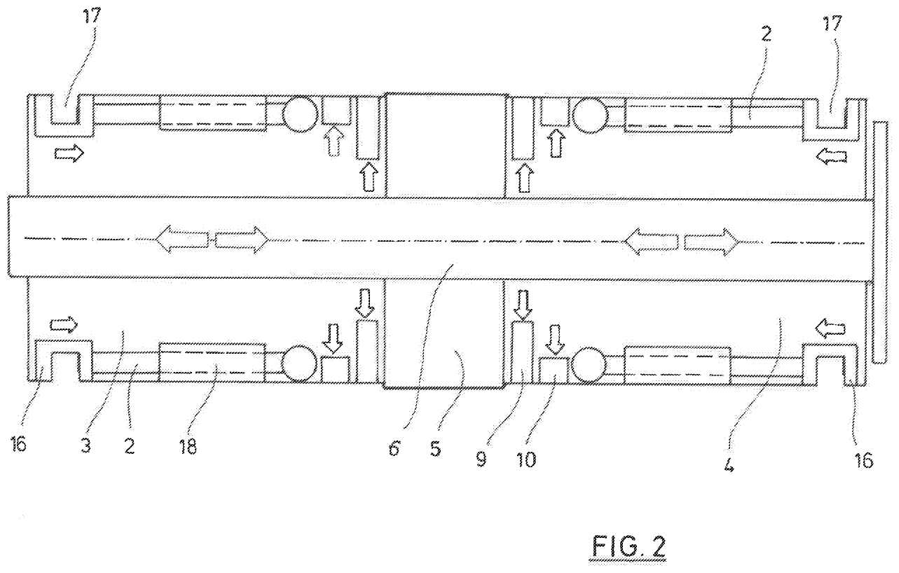

FIG. 2 shows a longitudinal section through a tire-building drum according to the invention with mechanical ply turn-up without any material applied to it,

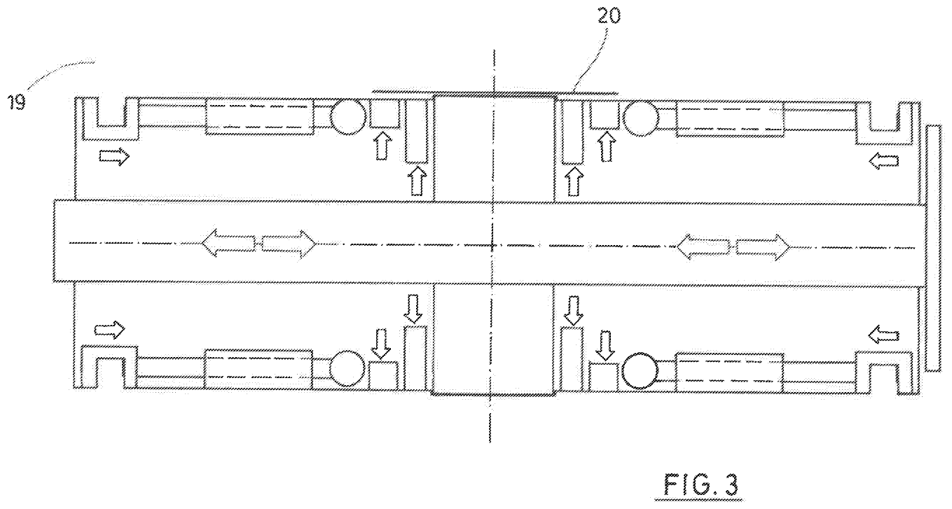

FIG. 3 shows a longitudinal section through the tire-building drum shown in FIG. 2 with the inner liner material applied to it,

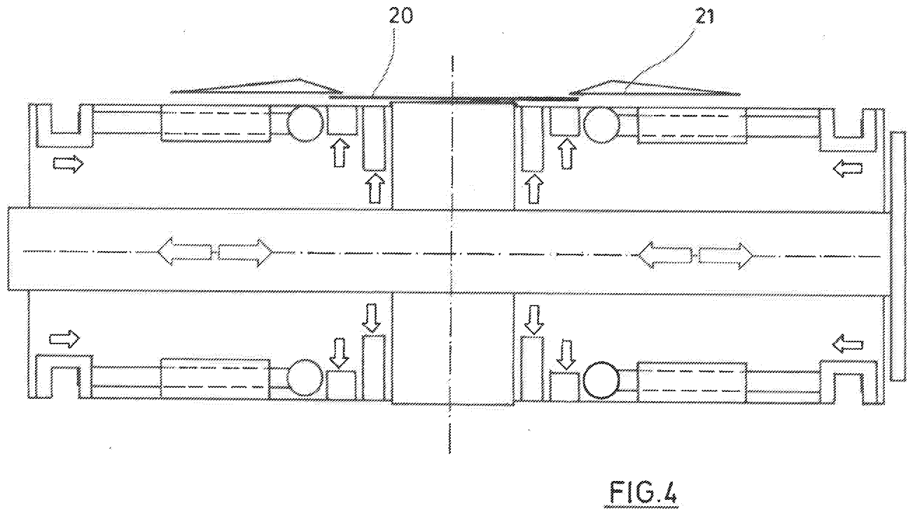

FIG. 4 shows a longitudinal section through the tire-building drum shown in FIG. 3 with side wall material applied in addition,

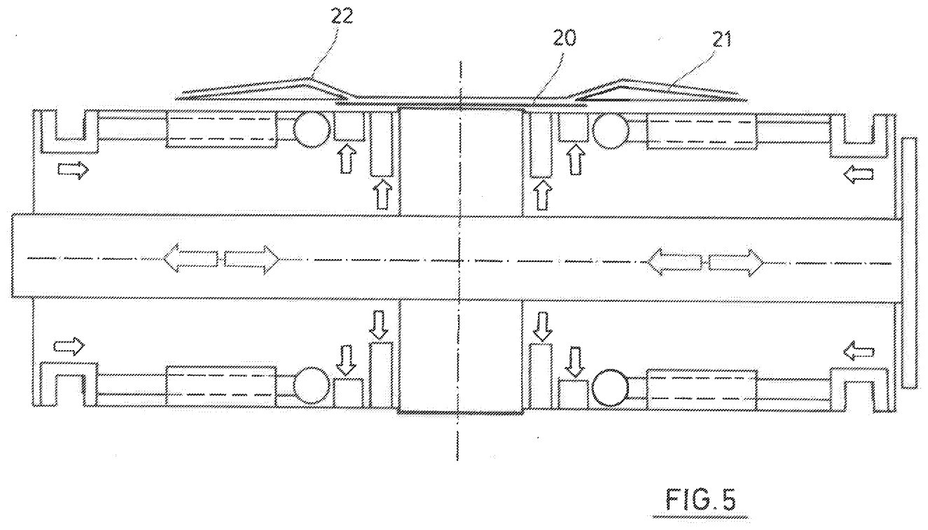

FIG. 5 shows a longitudinal section through the tire-building drum shown in FIG. 4 with body ply material applied in addition,

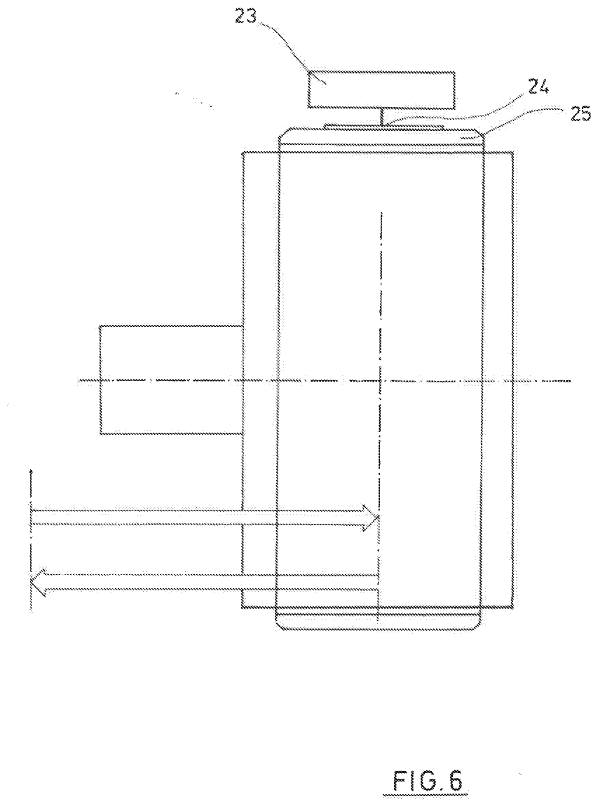

FIG. 6 shows a representation of the transfer from tire-building drum of tread server to the tire-building ring in a device according to the invention for producing tires,

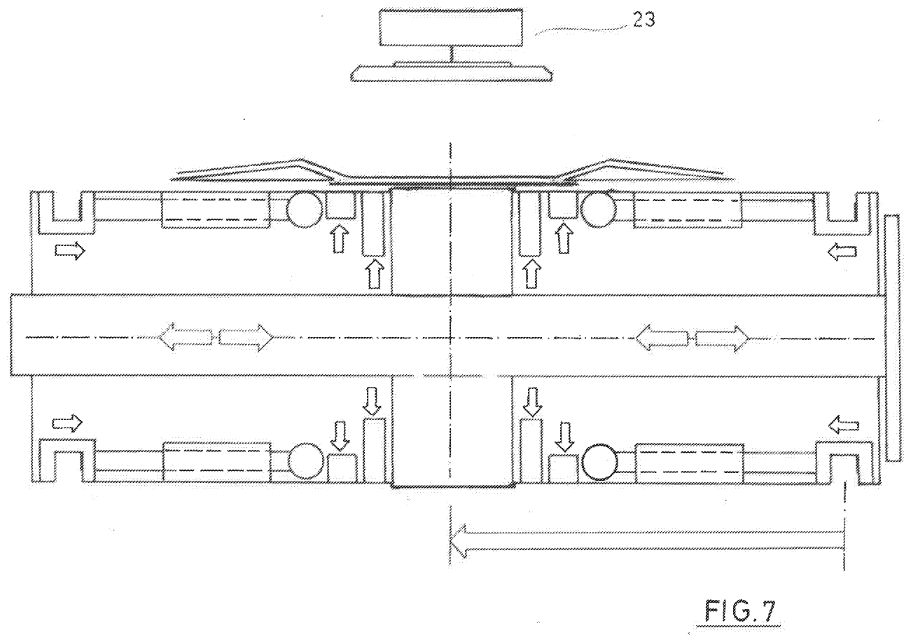

FIG. 7 shows a longitudinal section through the tire-building drum shown in FIG. 5 positioned in the tire-building ring,

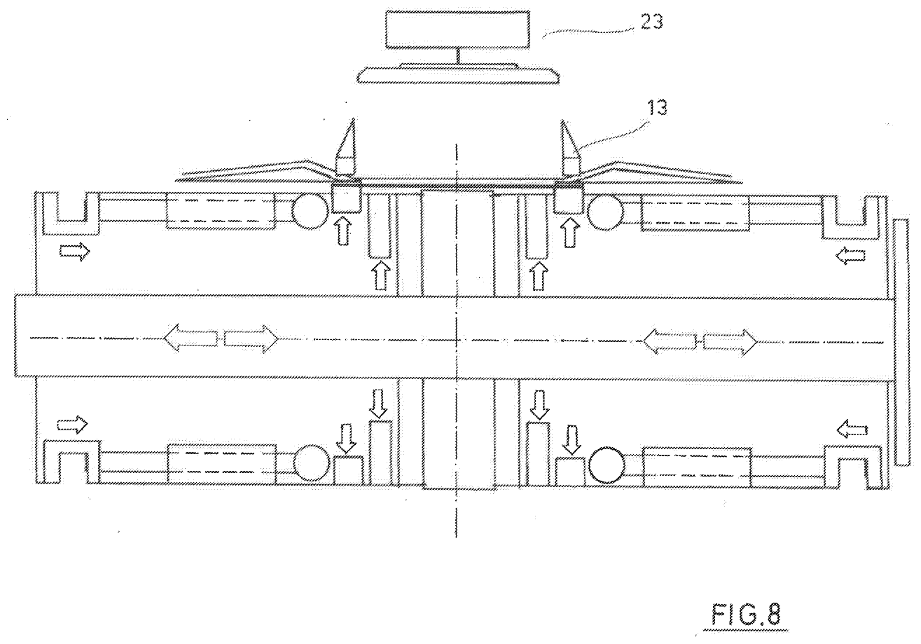

FIG. 8 shows a longitudinal section through the tire-building drum shown in FIG. 7 with cores set in addition,

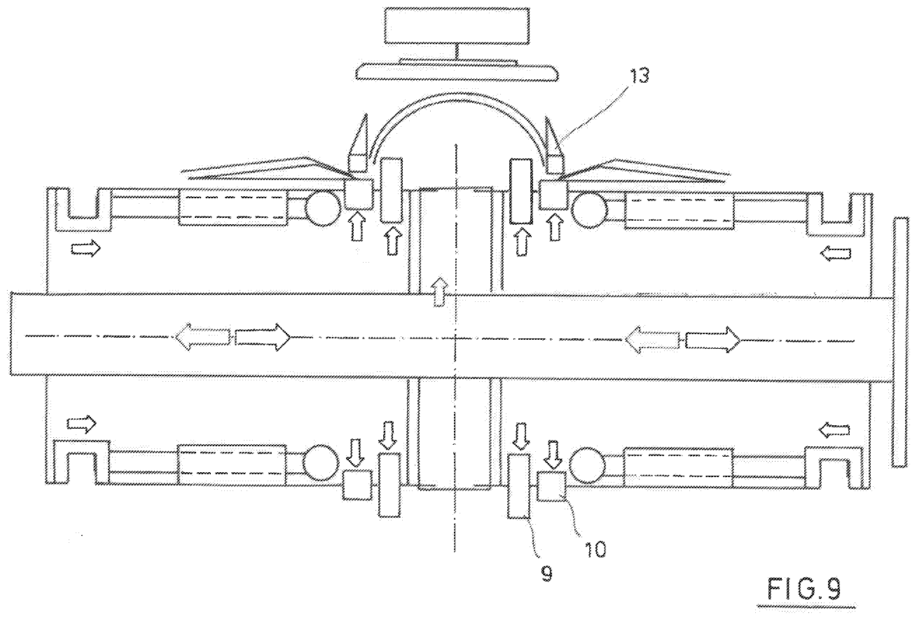

FIG. 9 shows a longitudinal section through the tire-building drum shown in FIG. 8 with the inner shoulder extended and the carcass ventilated,

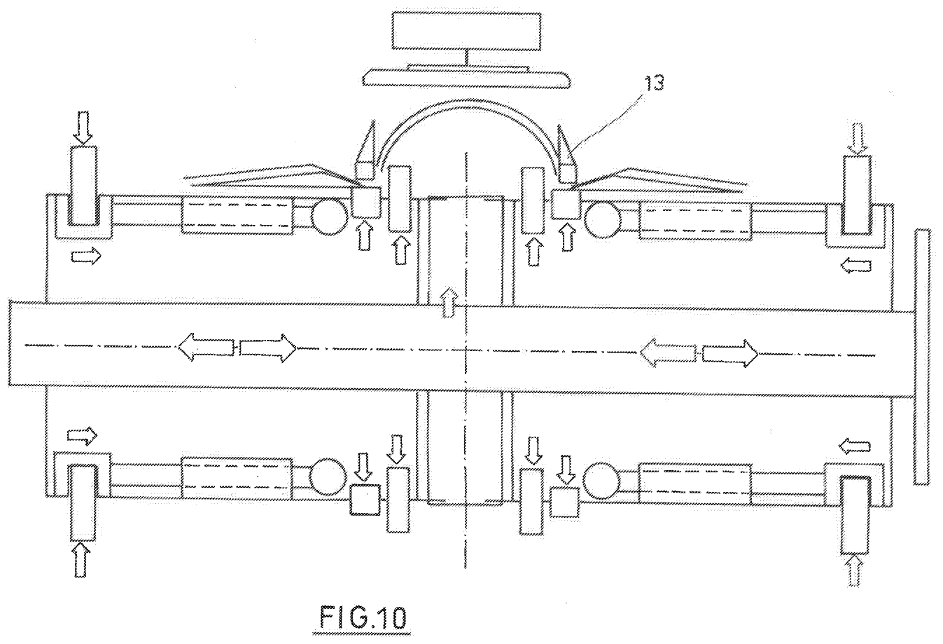

FIG. 10 shows a longitudinal section through the tire-building drum shown in FIG. 9 with carriers positioned in the ring grooves of the pushing rings,

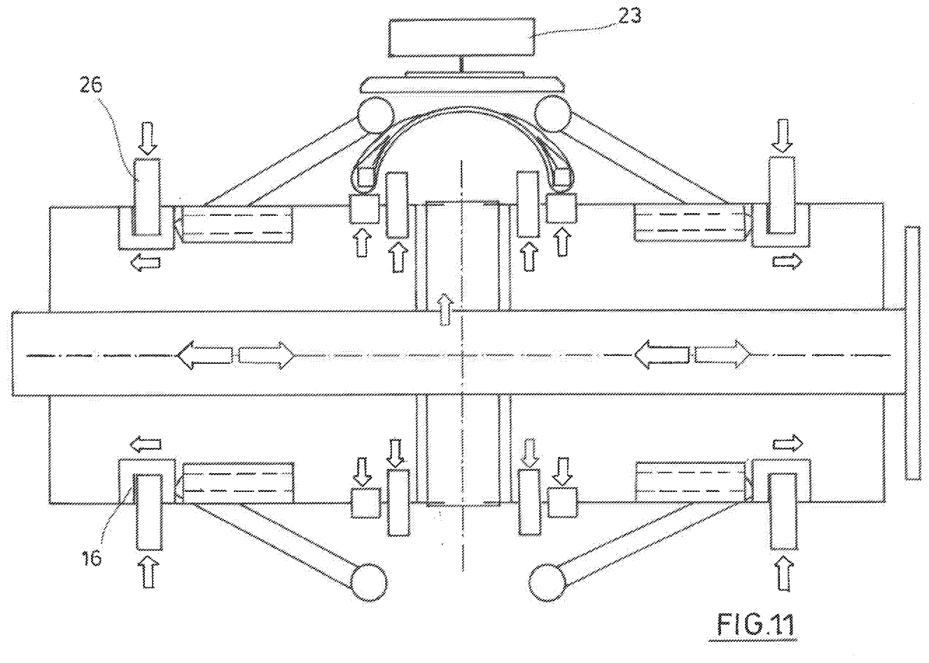

FIG. 11 shows a longitudinal section through the tire-building drum shown in FIG. 10 with turn-up fingers moved to the ply turn-up,

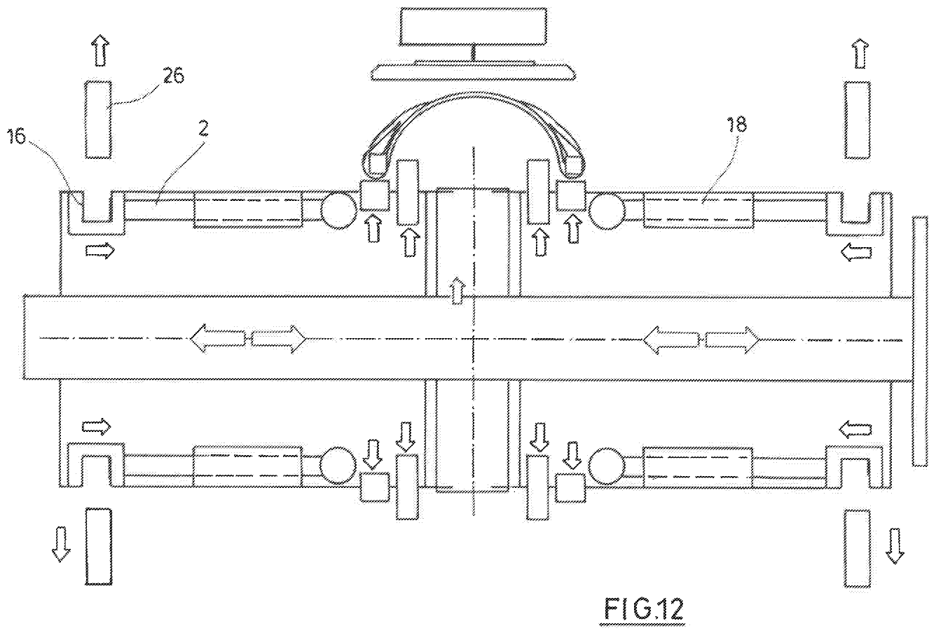

FIG. 12 shows a longitudinal section through the tire-building drum shown in FIG. 11 after the turn-up process and with the ring groove cleared,

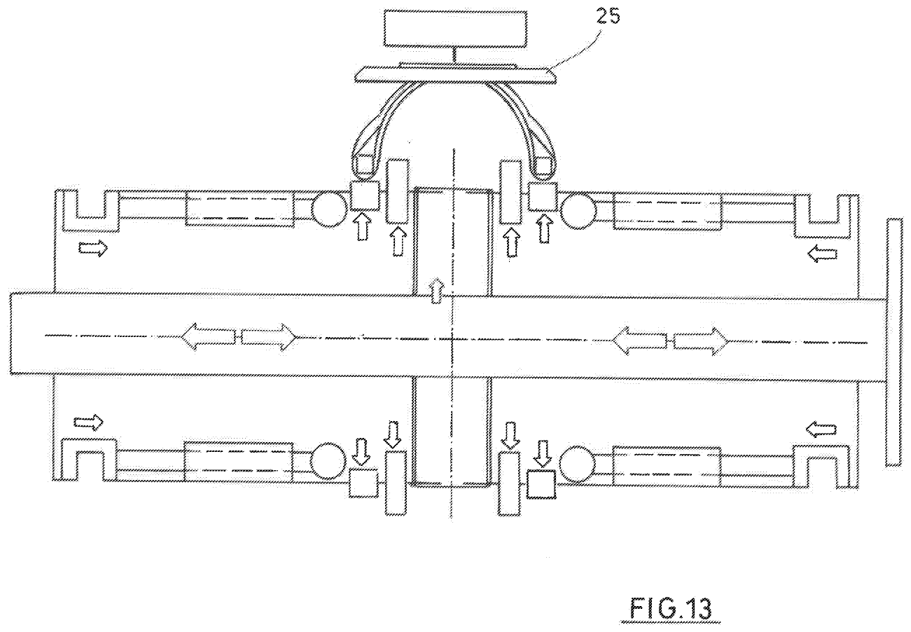

FIG. 13 shows a longitudinal section through the tire-building drum shown in FIG. 12 with a belt package additionally connected to the carcass,

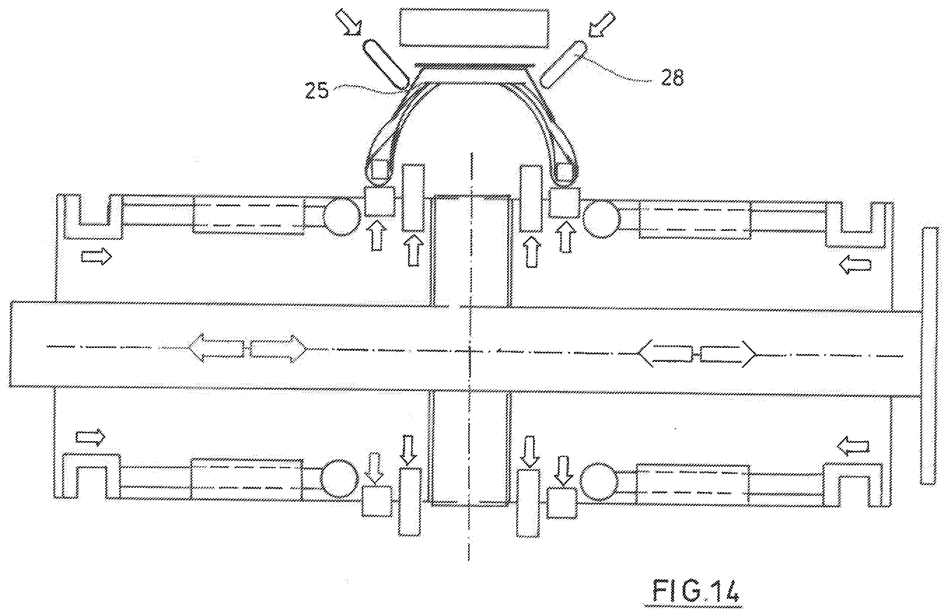

FIG. 14 shows a longitudinal section through the tire-building drum shown in FIG. 13 with an active roll-on device for the tread,

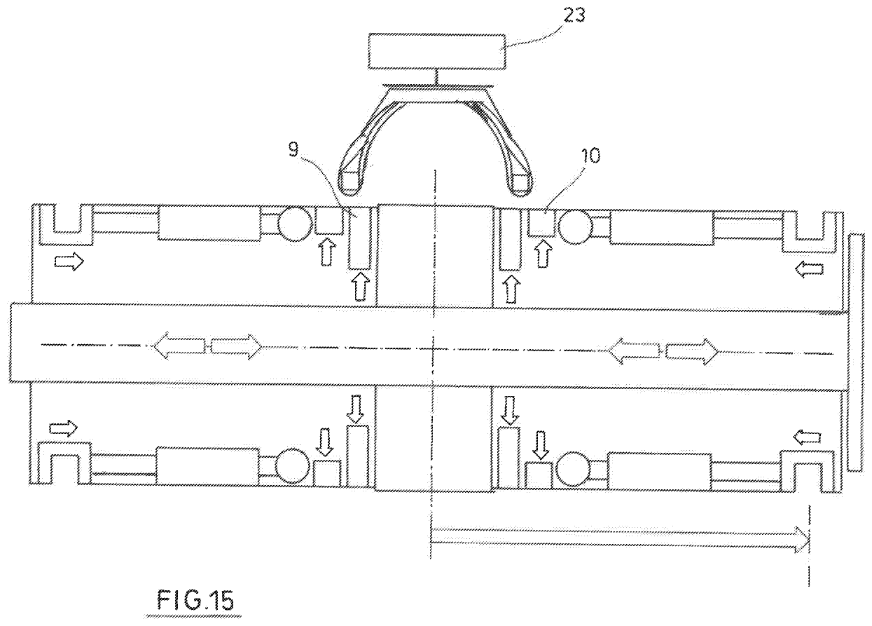

FIG. 15 shows a longitudinal section through the tire-building drum shown in FIG. 14 with the core clamping and inner shoulder retracted,

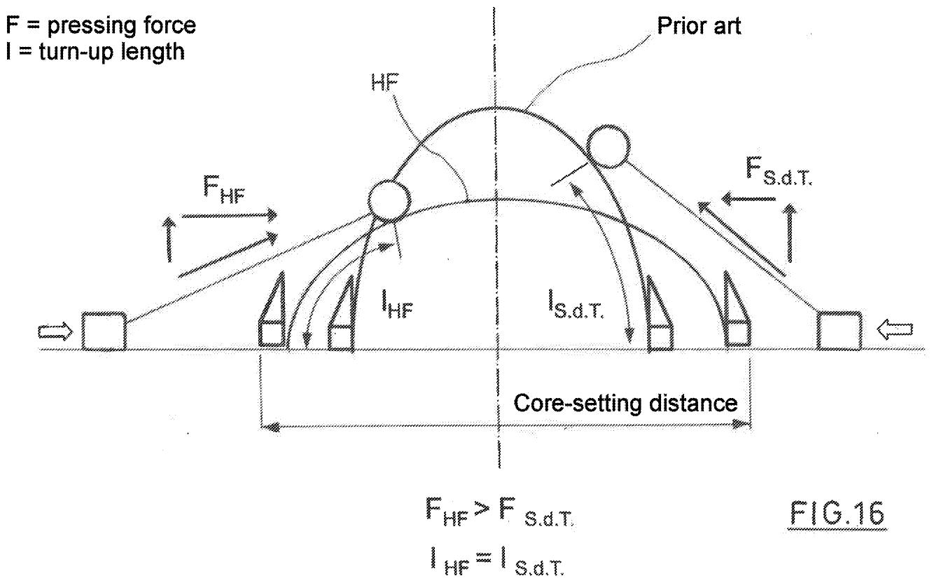

FIG. 16 shows a schematic representation of the core-setting intervals and the resulting pressing forces.

The tire-building drum shown in FIG. 1 is made up of a left drum half (3) and a right drum half (4) which are in turn each mounted on a drum shaft (6). The two drum halves (3, 4) form a cylindrical round body in conjunction with a drum center part (5) and an integrated core tensioning device (10). The individual carcass plies (12, 15) are processed on this round body and formed into a tire blank.

Mechanical bead supports (9) which extend radially stabilize the bead region inwardly in conjunction with the core tensioning device (10). The two drum halves (3, 4) are locked on the slotted drum shaft (6). Axial adjustment in the case of the drum halves (3, 4) is produced using a motor which turns a spindle positioned in the carcass machine or in the drum shaft (6).

A typical operational process is described below. The building materials for producing a carcass are applied to the cylindrical drum body (3, 4, 5) with retracted turn-up fingers (2), core tensioning device (10) and mechanical bead supports (9). Two cores (13) are then placed on the drum body (3, 4, 5) (to the left/right) with a segmented, ring-shaped core-setting device (1). The core-setting device (1) is made up of a symmetrical left and right half.

The core-setting device (1) is in turn mounted on at least one left/right-handed spindle which can be moved axially in a precise and program-controlled manner via servo motors. Following the setting of the cores (13), the left and right core-setting devices (1) move outwards. The core-setting devices (1) used as pushing devices move radially inwards into the pushing rings (16) of the drum halves (3, 4). In this way, the servo-controlled connection is made between the core-setting device (1) and the turn-up fingers (2).

The spacing of the cores (13) is reduced by the rotation of the at least one spindle. The bead support (9) was radially extended beforehand and forms a stable mount for the following ply turn-up process. A plurality of turn-up fingers (2) which are arranged very closely on the left and right drum half (3, 4) raise the carcass material lying on them.

As the spaces between the cores (13) are increasingly reduced and compressed air is simultaneously fed into the bulging carcass (12), the turn-up fingers (2) are deflected outwardly via the axial movement. The rollers of the left and right turn-up fingers (2) roll the carcass material (15) perfectly symmetrically onto the carcass (12) (tire blank) which is being formed. The outwardly deflected turn-up fingers (2) create increasing spaces in the roller head region which are in turn filled by a double-roller mechanism (2. 1).

In this way, planar rolling is achieved during the ply turn-up and air inclusions are thereby avoided. Following completion of the ply turn-up, further blank components are fed from the external side.

The tire-building drum is provided with an external, where necessary coupled, servo-controlled core setting device (1). In this way, absolute synchronous running of the roller systems of both drum halves (3, 4) is guaranteed. At the same time, the synchronous running of the motor produces no stick-slip effects or difficult/unstable adjustments of a pneumatic turn-up finger activation. Consequently, substantially improved true running quality/uniformity can be expected for the user, particularly with regard to improved tapering and lateral force fluctuations.

The tire-building drum according to the invention has further advantages to offer in its modular design. The region of the core clamp realized with the help of a core-clamping device (10) and the bead support (9) may have the same design and produce a two-bellow drum type. Absolutely secure core-clamping in conjunction with a radially extendable mechanical bead support (9) thereby exists.

Despite the use of turn-up fingers (2) with all their intermediate spaces, the tire-building drum has an absolutely penetrating axial bearing surface to create an automatic spliced seam.

FIG. 2 shows a further tire-building drum according to the invention with pushing rings (16) which each have a ring groove (17). The turn-up fingers (2) lie within the tire-building drum in longitudinal grooves and are connected to the pushing rings (16) in a rotationally movable manner. The turn-up fingers (2) are advantageously guided with the help of forced control (18). Furthermore, the embodiment shown of a tire-building drum according to the invention is made up of two drum halves (3, 4) which are defined as outboard (3) or inboard drum halves (4) depending on their position relative to the bearing of the drum shaft (6). Located between the drum halves (3, 4) is the center part (5), alongside which the core-clamping device (10) and the shoulder support (9) are situated.

FIG. 3 shows a process step of the method according to the invention for producing tires. While the tire-building drum is located centrally within the ply server (19) of the device according to the invention, the different material plies are applied one after the other. FIG. 3 shows the drum after the inner liner material (20) has been applied. The side wall material (21) is then applied, as illustrated in FIG. 4. In FIG. 5 the drum is shown following application of the body ply material (22) which is fitted to the previously laid plies.

FIG. 6 shows a next step in the method according to the invention for producing tires. The belt drum (30) onto which a belt package (25) was previously applied in the region of the tread server (29) is transferred from the tread server (29) to the tire-building ring (23). The tire-building ring (23) has a gripper (24) which receives and holds the belt package (25) of the tire blank from the belt drum (30). The belt drum (30) is then transferred from the tire-building ring (23) back to the tread server (29). The tire-building drum is positioned centrally below the belt package (25) in the tire-building ring (23).

FIG. 7 shows the longitudinal section of a tire-building drum according to the invention which is located within the tire-building ring (23) according to the process step shown in FIG. 6.

The following step illustrated in FIG. 8 of the method according to the invention is the setting of cores (13) which are fixed radially outwards with the help of a core-clamping device (10) method.

FIG. 9 shows the next step in the method for which the inner shoulders of the bead support (9) are extended and the carcass is ventilated by means of a surplus pressure supplied from within the tire-building drum.

As shown in FIG. 10, the carriers (26) realized with the help of the core-setting device (1) are then moved in the ring grooves (17) of the pushing rings (16), as a result of which said rings are coupled to the drive integrated in the tire-building ring (23).

With the help of the axial, synchronous and contra-rotating drive of the spindles, the carriers (26) and therefore also the pushing rings (16) are moved towards the center of the tire-building ring (23), as a result of which the turn-up fingers (2) are extended, as shown in FIG. 11. During this, the turn-up fingers (2) which are advantageously uniformly distributed in the circumferential direction initially run over rollers on their side facing the tire blank up an obliquely arranged, ring-shaped mechanical surface which is not shown, after which the elastomer material of the previously fitted plies is aligned and turned up. In a further step, the rollers on the turn-up fingers (2) press the material onto the carcass.

As shown in FIG. 12, the turn-up fingers (2) are then folded in again by a movement of the pushing rings (16) and lowered into the longitudinal grooves in the tire-building drum.

According to the prior art, a plurality of spiral springs which produce restoring forces run in the circumferential direction on the turn-up fingers (2). According to the invention, a forced return (18) is realized in addition, so that the springs only have to apply relatively small restoring forces. The problem of the spring forces is that, depending on the positioning and the length of the turn-up fingers (2), some of the spring forces act inwardly in a radial direction, whereas a further force component acts via the rollers of the turn-up fingers (2) on the side wall of the tire being built.

Next the carriers (26) are retracted and once again clear the ring grooves (17) in the sliding rings (16).

FIG. 13 shows the next process step in a method according to the invention for producing tires in which the core distance is set at the final position and the carcass is connected to the belt package (25). The belt package (25) configured as a tread is then rolled onto the carcass by means of a rolling-on device (28) present in the tire-building ring (23), as illustrated in FIG. 14.

By introducing the core-clamping device (10) and inner shoulders of the bead support (9), the tire blank is then released from the tire-building drum, as depicted in FIG. 15.

FIG. 16 shows an illustration of the pressing force F occurring due to the core-setting according to the invention in the turn-up process. Due to the greater, or at least equal, spacing of the set cores (13) in respect of the final core-setting distance during the tire-building process, the carcass of the tire blank has a flatter or, at most, equally high, contour compared with the prior art. When the turn-up length I is the same, the relevant horizontal force component of the force vector in the embodiment according to the invention of a device for producing tires is greater or at least the same size by comparison with the prior art.

1-12. (canceled)

13. A device for producing tires, comprising: a tire-building drum; and a device for realizing a ply turn-up for producing uncured tire blanks, wherein the ply turn-up device includes by a plurality of turn-up fingers coupled to a drive unit arranged outside the tire-building drum.

14. The device according to claim 13, wherein the tire-building drum includes two drum halves, further comprising a pushing ring on each drum half, the turn-up fingers of the halves of the tire-building drum being coupled to the pushing ring on each drum half.

15. The device for producing tires according to claim 13, wherein the drive unit is a servo-drive.

16. The device for producing tires according to claim 14, wherein the pushing rings each have a ring groove for coupling to the drive unit for the turn-up fingers.

17. The device for producing tires according to claim 16, wherein the drive unit of the turn-up fingers includes a plurality of separately driven spindles mounted in a fixed tire-building ring and driven synchronously in opposite directions.

18. The device for producing tires according to claim 17, further comprising radially movable carriers that couple the drive unit in the fixed tire-building ring to the pushing ring of the tire-building drum.

19. The device for producing tires according to claim 13, further comprising a carcass machine configured so that tire blanks are producible by both a flat-building method and a crown-building method using different tire-building drums.

20. The device for producing tires according to claim 19, further comprising a second drive unit arranged in the carcass machine so as to provide a flexible production of tire blanks using the flat-building or the crown-building method.

21. The device for producing tires according to claim 13, wherein a core-setting distance is defined during a turn-up process so that a core-setting distance that is greater than, or equal to, a smallest core-to-core dimension during a remaining tire-building process is achieved so that a more efficient, usable material pressing force is achieved,

22. A method for producing tires, comprising driving a turn-up of tire material with a drive mounted outside a tire-building drum.

23. The method according to claim 22, including synchronously actuating a turn-up mechanism on both sides of the tire-building drum to achieve a uniform turn-up.

24. The method according to claim 22, includes creating an advantageous force/angle ratio that allows more effective use of material pressing force by core-setting with a core-to-core distance that is greater than, or equal to, a smallest core interval covered during a remaining tire-building process.
